(19) United States
(12) Patent Application Publication
(10) Pub. No.: US 2007/0134094 A1
(43) Pub. Date: Jun. 14, 2007

(54) Rotor apparatus and turbine system incorporating same

(76) Inventor: Stephen Gregory, Toronto (CA)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/297,734

(22) Filed: Dec. 8, 2005

(51) Int. Cl. B64C 11/00

(52) U.S. Cl. 416/87

(57) ABSTRACT

Rotor apparatus comprising at least one hub mounted to rotate about a central axis, a plurality of arms extending outwardly from the hub, a plurality of slots in the hub opening outwardly of the hub, and a plurality of vertical blades connected to the arms, wherein each one of the plurality of arms is releasably engaged in a respective one of a plurality of slots. The rotor apparatus may be implemented in a turbine system also comprising a shaft, shaft support means, a frame, mounting means, and generation means.

### FIELD OF THE INVENTION

The present invention relates to hydro turbine systems.

### BACKGROUND OF THE INVENTION

Darrieus-style vertical axis turbines were initially developed in the field of wind power generation. These turbines typically have straight airfoil-shaped blades oriented transversely to the fluid flow and parallel to the axis of rotation.

A number of Darrieus-style turbine systems have been developed for hydro applications. One such system is disclosed at www.bluenergy.com. This system is an ocean current turbine system comprising a turbine mounted in a concrete marine caisson which is anchored to the ocean floor. Water flows directly through the turbine by way of a duct. The generator and gear box are mounted on top of the caisson above the water level.

Another Darrieus-style turbine system is disclosed in U.S. Pat. No. 6,856,036 (Belinsky). In this ocean current system, a number of Darrieus-style turbines are mounted on a semi-submersible platform so that the turbines are mounted low enough in the water to avoid wave actions.

These systems are all suited for ocean sites where large structures may be used to support the turbine and generator equipment. The turbines themselves and the support structures are quite complex and are quite expensive to repair.

It is difficult to apply these turbine systems to low-depth situations, such as small and medium sized river sites. Systems installed in small and medium sized river sites also have the additional challenge of dealing with damage caused by debris carried by the often fast-moving currents (e.g. logs). Quite often, a “trash rack” must be installed to deflect heavier pieces of debris so that damage to the turbine is minimized.

### SUMMARY OF THE INVENTION

According to an aspect of an embodiment of the invention, there is provided a rotor apparatus comprising at least one hub mounted to rotate about a central axis, a plurality of arms extending outwardly from the hub, a plurality of slots in the hub opening outwardly of the hub; and a plurality of vertical blades connected to the arms. Each one of the plurality of arms is releasably engaged in a respective one of a plurality of slots.

The hub may comprise a central body and a plurality of extensions extending radially from the central body. Each one of the plurality of slots may be located in a respective one of the plurality of extensions. Each one of the plurality of arms may fit tightly within a corresponding one of the plurality of slots and may be secured therein using means selected from the group comprising welding, spring pins, pins, dowels, lips, glue, soldering and brazing.

According to another aspect of an embodiment of the invention, there is provided a turbine system comprising a rotor apparatus, a stainless steel shaft, shaft support means, a frame, mounting means and generation means. The rotor is coupled to the shaft, the shaft is coupled to the shaft support means and to the generation means and the frame is coupled to the mounting means.

The rotor apparatus may comprise at least one hub mounted to rotate about a central axis, a plurality of arms extending outwardly from the hub, a plurality of slots in the hub opening outwardly of the hub; and a plurality of vertical blades connected to the arms. Each one of the plurality of arms may releasably engaged in a respective one of a plurality of slots.

The mounting means may be an outboard motor mount and the turbine system may be thus supported on a boat. Alternatively, the mounting means may comprise a standard motor mount and the frame may be connected to a support beam extending across a body of water. The motor mount may comprise shear pins and pivot means to lift the rotor apparatus out of the water in the event that it is hit by debris or the like.

Other aspects and features of the present invention will be apparent to those of ordinary skill in the art from a review of the following detailed description when considered in conjunction with the drawings.

### BRIEF DESCRIPTION OF THE DRAWINGS

Reference will now be made by way of example, to the accompanying drawings which show example embodiments of the present invention, and in which:

FIG. 1 is a perspective view of a rotor apparatus;

FIG. 2 is a perspective view of a portion of a rotor apparatus;

FIG. 3 is a schematic front view of a turbine system; and

FIG. 4 illustrates a portion of a front view of a turbine system.

### DESCRIPTION OF THE EXAMPLE EMBODIMENTS

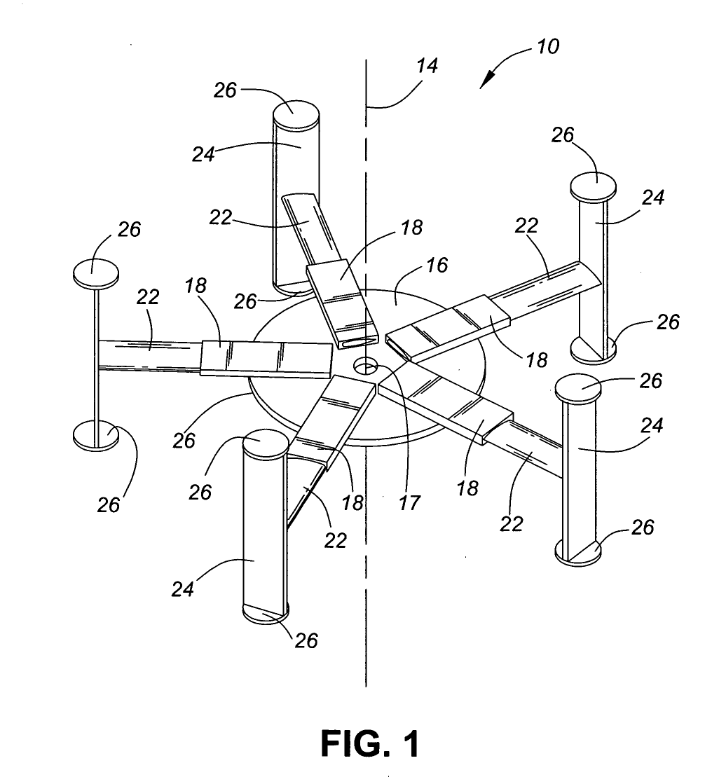

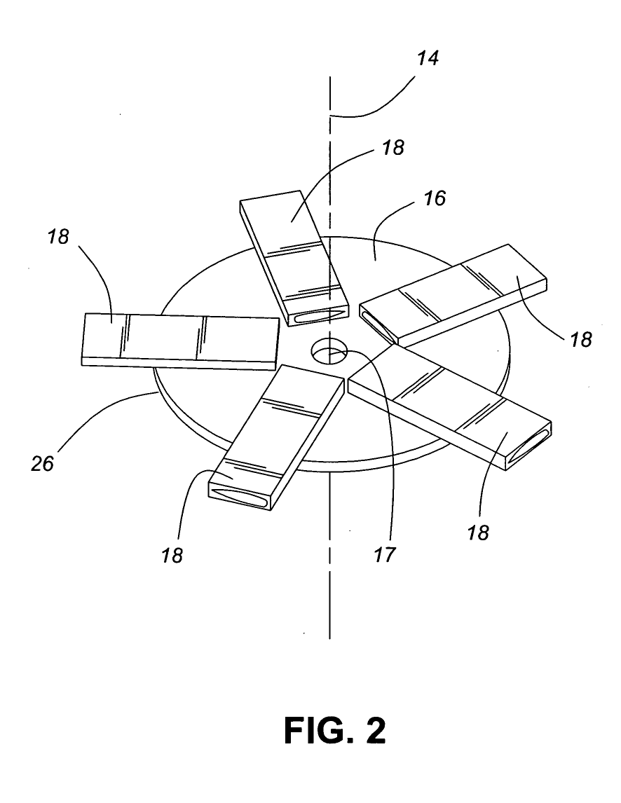

According to an example embodiment, FIG. 1 illustrates a turbine rotor apparatus 10 comprising at least one hub 12 mounted for rotation around a vertical central axis 14 of the hub 12. The hub 12 comprises a central body 16 and a plurality of extensions 18 extending outwardly and radially from said central body. Each extension comprises a slot 20, as shown in more detail in FIG. 2, opening outwardly of said hub for receiving an end of one of a plurality of arms 22. The arms 22 are releasably engaged in the slots 20.

Alternatively, the slots may be located in the central body 16 and the extensions 18 may be disposed of.

Preferably, the arms 22 fit tightly into the slots 20. They may be further secured using one of a number of suitable securing means such as welding, pins, dowels, lips, glue, soldering and brazing. On smaller scale rotor apparatus, spring pins may be used. On larger scale rotor apparatus, solid pins may be used.

In the example embodiment shown in FIGS. 1 and 2, each of the slots 20 extends the entire length of the corresponding extension 18. It should be understood, however, that each of the slots 20 may only extend over a portion of the corresponding extension 18.

Each one of the arms 22 is connected to one of a plurality of vertical blades 24. If a single hub 12 is used, the arms 22 are connected to the vertical midpoint of the vertical blades 24, as shown in FIG. 1. It should be understood, however, that the arms 22 may be connected at any suitable position on the vertical blades 24. The cross-section of each one of the vertical blades 24 is airfoil shaped.

The central body 16 may be a disk having a central opening 17 for receiving a drive shaft. The extensions 18 may be welded to the top surface of the central body 16. The extensions 18 may generally rectangular and arranged so that the central corners of each extension abut the corners of adjacent extensions (e.g. the corners that are proximal to the axis of rotation of the rotor). Alternatively, as shown in FIGS. 1 and 2, the central corners of each extension may be spaced from adjacent extensions.

The turbine rotor apparatus 10 may also comprise a plurality of protrusions 26, namely flat, disk-shaped extensions (sometimes referred to as winglets) attached to each tip of each one of the blades 24. These protrusions 26 increase the efficiency of the turbine rotor apparatus and prevent leakage of the high pressure zone.

The arms 22 may have the same cross-sectional profile as the blades 24. This reduces the cost of manufacturing the arm components as both the blades and the arms may be cut to the appropriate length from a single stock and to reduce the drag losses in the water. The blades, arms and hub components of the turbine may each be made from solid 6063T5 aluminum alloy as this material offers the required resistance to corrosion and a smooth surface finish. The arms 22 may also have a different profile than the blades 24. For example, the arms 22 may be flat and the blades 24 may be aerofoil shaped.

The turbine rotor apparatus 10 comprises between four and seven blades. It is preferable to have at least three blades because the turbine will be “self-starting” (e.g. it will begin to rotate without the application of an external force) although it should be understood that any suitable number of blades may be used in conjunction with starting means, where appropriate.

The rotor apparatus described above may be mounted on a stainless steel shaft and supported by two bearings. These bearings may be standard stainless steel pillow block bearings, such as those sold under the name Sealmaster. If these bearings are used, they must be mounted above the water line. Alternatively, the shaft may be supported by bearings suitable to be used underwater.

The frame supporting the two bearings is a channel section or flat plate, which may be modified to accommodate a variety of mounting means. The end of the shaft 28 is received by the central opening 17. One end of the shaft 28 may comprise a standard spigot mount having a step and a threaded bore for receiving a bolt.

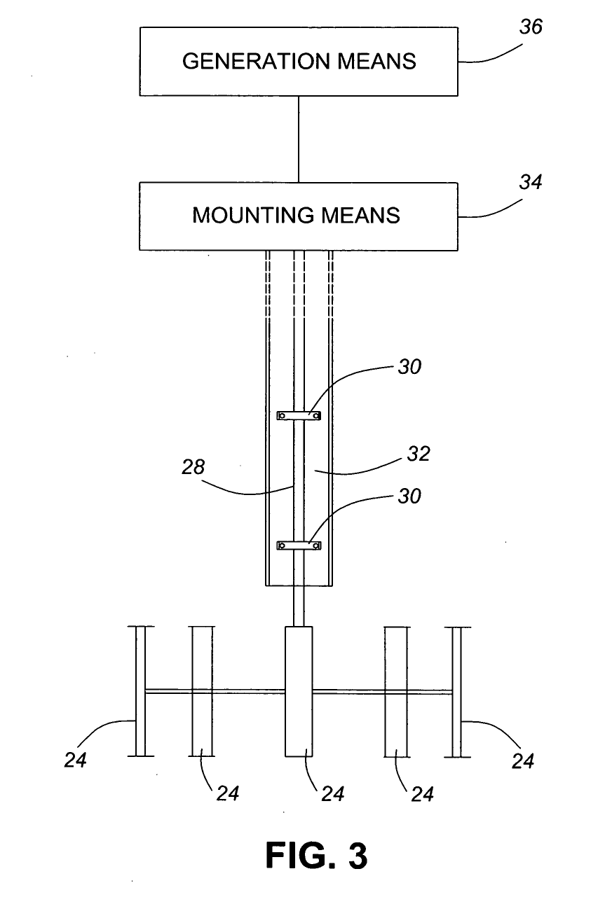

According to an example embodiment of the invention, FIG. 3 illustrates a portion of a turbine system comprising a turbine rotor 10, a stainless steel shaft 28, shaft support means and a frame 32. The shaft is supported by two pillow block bearings 30 which are mounted to the frame 32. The frame 32 may be a flat plate or a channel section.

The frame 32 is connected to a mounting means 34 and generation means 36 (i.e. a flexible coupling, a gearbox and an electrical generator). The electrical generator may be a permanent magnet D.C. generator, a brushless alternator or any other suitable electrical generator. The shaft 28 is connected to the flexible coupling. Power is transferred through the flexible coupling to the electrical generator. The flexible coupling compensates for misalignment.

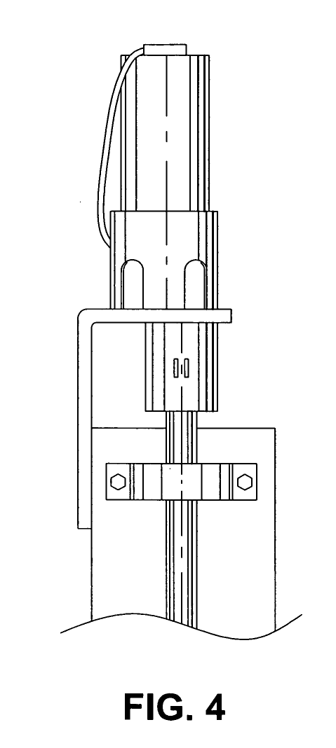

A portion of a front view of a turbine system in accordance with an example embodiment of the invention is shown in FIG. 4. The turbine shaft 28 is supported by two pillow block bearings 30 (only one bearing is shown) on a frame 32, shown here as a flat plate. Generation means 36 is shown comprising a flexible coupling 38, a bracket 40 attached to the frame 32, a gearbox 42 and an electrical generator 44, wherein the gearbox 42 and the electrical generator 44 are supported by the bracket 40. A number of electrical options are available depending on site requirements.

According to an example embodiment, the mounting means 34 is an outboard motor mount. Suitable outboard motor mounts are manufactured by Mercury Marine although it should be understood that any suitable outboard motor mount may be used. The turbine system may be thus installed on a boat, for example an anchored or docked boat. Where necessary, the mounting bolts of the outboard motor mount may be modified to suit the frame 32. Preferably, an outboard motor mount fitted with shear pins is used so that the rotor apparatus will rise up out of the water if it is hit by debris or the like with sufficient force.

According to an example embodiment, the mounting means 34 comprises a standard motor mount and the frame 32 is connected to a support beam. In some applications, the support beam may extend across a body of water such as a river or stream. Shear pins and pivot means (such as a hinge) are used in the motor mount so that the rotor apparatus will rise out of the water if it is hit by debris or the like with sufficient force. In this way, damage caused by contact with debris in the water will be mitigated.

Alternatively, the turbine system may be connected to a support beam and the rotor apparatus anchored to the bed of the body of water (e.g. the river bed). If a significant amount of debris is carried by the body of water, protection means, such as a “trash rack” must be installed to deflect heavier pieces of debris so that damage to the turbine is minimized.

According to an example embodiment, the rotor apparatus described above may be used in a submerged turbine network. Such a network comprises one or more rotor apparatuses, one or more corresponding pumps driven by the one or more rotor apparatuses, one or more corresponding conduits and a remote generator. The one or more rotor apparatuses may each be anchored to the bed of the body of water using, for example, a concrete block or a plurality of posts. Alternatively, the one or more rotor apparatuses may be suspended from a support.

Each pump is coupled to a respective one of the rotor apparatuses via a gearbox and a pair of bearings. Alternatively, the pumps may be operated without a gearbox (for example if piston pumps are used). As the rotor apparatuses rotate, each pump drives high-pressure water via its conduit to the remote generator which comprises an additional hydro turbine for which the working fluid is the high pressure water from the conduits or any other environmentally benign fluid. The remote generator may be located on shore, or on a suitable platform. The conduits may each be connected to a single main conduit.

Embodiments of the rotor apparatus and turbine system described herein are particularly well-suited to low-depth sites such as small and medium sized rivers and other sites where debris may be an issue because the arms of the rotor apparatus can be easily replaced without having to replace the entire rotor apparatus.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A rotor apparatus comprising:
at least one hub mounted to rotate about a central axis;
a plurality of slots in said hub opening outwardly of said hub;
a plurality of arms extending outwardly from said hub; and
a plurality of vertical blades connected to said arms,
wherein each one of said plurality of arms is releasably engaged in a respective one of a plurality of slots.

2. A rotor apparatus according to claim 1, wherein said hub comprises a central body and a plurality of extensions extending radially from said central body.

3. A rotor apparatus according to claim 2, wherein said each one of said plurality of slots is located in a respective one of said plurality of extensions.

4. A rotor apparatus according to claim 1, wherein each one of said plurality of arms fits tightly within a corresponding one of said plurality of slots.

5. A rotor apparatus according to claim 1, wherein each one of said plurality of arms is secured in a corresponding one of said plurality of slots using means selected from the group comprising welding, spring pins, pins, dowels, lips, glue, soldering and brazing.

6. A rotor apparatus according to claim 1, wherein said plurality of arms extend from a single hub and the ends of said arms are connected to a vertical midpoint of each one of said corresponding blades.

7. A rotor apparatus according to claim 1, wherein a cross-section of each one of said blades is airfoil shaped.

8. A rotor apparatus according to claim 1, wherein each tip of each one of said blades comprises a winglet.

9. A rotor apparatus according to claim 1, wherein said arms have the same cross-sectional profile as said blades.

10. A rotor apparatus according to claim 1, wherein said plurality of blades comprises between 4 and 7 blades.

11. A turbine system comprising:
a rotor apparatus;
a shaft;
shaft support means;
a frame;
mounting means; and
generation means,
wherein said rotor is coupled to said shaft, said shaft is coupled to said shaft support means and to said generation means and said frame is coupled to said mounting means.

12. A turbine system according to claim 11, wherein said shaft support means comprises a pair of pillow block bearings.

13. A turbine system according to claim 11, wherein the frame is a flat plate.

14. A turbine system according to claim 11, wherein the frame is a channel section.

15. A turbine system according to claim 11, wherein the generation means comprises a flexible coupling, a gearbox and an electrical generator.

16. A turbine system according to claim 15, wherein the electrical generator is one of a permanent magnet D.C. generator and a brushless alternator.

17. A turbine system according to claim 11, wherein the rotor is the rotor of any one of claims 1 to 10.

18. A turbine system according to claim 11, wherein said mounting means is a standard outboard motor mount.

19. A turbine system according to claim 18, wherein the mounting means is supported on a boat.

20. A turbine system according to claim 18, wherein mounting bolts of said outboard motor mount are modified to suit said frame.

21. A turbine system according to claim 11, wherein said mounting means comprises a standard motor mount and the frame 32 is connected to a support beam.

22. A turbine system according to claim 21, wherein said support beam extends across a body of water.

23. A turbine system according to claim 21, wherein said motor mount comprises shear pins and pivot means.
